(19) United States
(12) Patent Application Publication
(10) Pub. No.: US 2024/0264967 A1
(43) Pub. Date: Aug. 8, 2024

(54) HOTSWAP SPACE HARDWARE EXCHANGER

(71) Applicant: THERMASAT, INC., SCOTTSDALE, AZ (US)

(72) Inventors: TROY MICHAEL HOWE, SCOTTSDALE, AZ (US); JACK R. MILLER, SCOTTSDALE, AZ (US)

(73) Assignee: THERMASAT, INC., SCOTTSDALE, AZ (US)

(21) Appl. No.: 18/429,180

(22) Filed: Jan. 31, 2024

Related U.S. Application Data
(60) Provisional application No. 63/482,973, filed on Feb. 2, 2023.

(51) Int. Cl. G06F 13/40; G06F 1/18

(52) U.S. Cl. CPC G06F 13/4081; G06F 1/182

(57) ABSTRACT

A HotSwap system includes a HotSwap bus and HotSwap cartridges containing payloads and subsystems. The HotSwap cartridges can be installed into or removed from the HotSwap bus, with the installation or removal involving the use of a HotSwap End Effector. Subsystems can be attached to the HotSwap cartridges and can interface with the HotSwap bus. The cartridges can accommodate current spacecraft standard subsystems or standard payloads, and are intended to be removed, replaced, or exchanged in orbit, including by a service vehicle or robot to allow for rapid replacement of old, used, or damaged spacecraft systems. The cartridges are secured in place in the HotSwap bus, which can allow power and communication between subsystems.

### CROSS-REFERENCE TO RELATED APPLICATIONS

This claims the benefit of the filing date of U.S. Provisional Patent Application No. 63/482,973, filed Feb. 2, 2023, the disclosure of which is incorporated, in its entirety, by this reference.

### SUMMARY

The HotSwap technology system has the potential to drastically reshape the future space economy. Numerous companies are producing constellations of satellites with a range of applications from remote sensing, internet of things, and asset tracking/management. These constellations require a large upfront cost to develop their payload, integrate a satellite, and launch them into orbit. Even after these satellites have been launched, they will eventually require replenishment as they naturally decay, or their payload is iterated up on to improve services. In all of these cases, an entirely new satellite will likely be launched to replace or improve the services of the constellation.

HotSwap will enable the launch of a single satellite into space with the ability to replace payloads and subsystems as new iterations become available. This drastically reduces the costs of maintaining a satellite constellation in multiple ways. Instead of spending considerable time and capital building a satellite, only individual subsystems need to be produced at a fraction of the cost of an entire spacecraft. Launch costs are a significant consideration of the cost of establishing and maintaining a constellation. Multiple HotSwap cartridges can be launched into orbit for the same mass as a complete satellite. Sending batches of payloads and other systems can drastically reduce the total launch cost of replenishing a constellation.

An increasingly common architecture for commercial spacecraft providers is payload hosting. Multiple payloads are hosted on a single spacecraft bus allowing for other companies to test hardware in an inexpensive manner without sending an entire satellite into orbit. While this technology is revolutionizing how companies get payloads into orbit, it is limited in several ways. Slots must be filled on the spacecraft platform prior to launch, and, sending new payloads into orbit requires an entirely new satellite. The lifetime of various payloads and the spacecraft may not match up well. This results in a payload that has accomplished its tasks but remains onboard the spacecraft taking up valuable real estate. The HotSwap system would allow these payload hosting satellites to remove and replace payloads without launching a new system or satellite. In the event where a payload could potentially damage the satellite, or the company is no longer operating, these payloads could be removed easily.

An increasing interest in return to Earth payloads and services has also been evolving in the past few years. HotSwap can enable these technologies by quickly extracting and replacing payloads from a satellite. These can be returned to Earth to extract the products or for inspection of the component.

### BRIEF DESCRIPTION OF THE DRAWINGS

Examples illustrative of embodiments of the disclosure are described below with reference to figures attached hereto. In the figures, identical structures, elements or parts that appear in more than one figure are generally labeled with the same numeral in all the figures in which they appear. Dimensions of components and features shown in the figures are generally chosen for convenience and clarity of presentation and are not necessarily shown to scale. Many of the figures presented are in the form of schematic illustrations and, as such, certain elements may be drawn greatly simplified or not-to-scale, for illustrative clarity. The figures are not intended to be production drawings. The figures are listed below.

FIG. 1 shows an exemplary infographic of a HotSwap system with subsystems attached to a removable cartridge which interfaces with and is secured in a HotSwap bus.

FIG. 2 shows two HotSwap cartridges with PC104 boards capable of interfacing with current spacecraft standards.

FIG. 3 shows another angle of a HotSwap cartridge as shown in FIG. 2 connected to the PC104 board. The copper leads were used to transfer power to an LED light indicating a successful power connection when inserted into the HotSwap bus.

FIG. 4 shows a successful connection with the mechanisms inside the Simulated HotSwap bus.

FIGS. 5A-5D show a cartridge placed inside the bus to produce a green light, which is then swapped out and replaced with another cartridge which produces a blue light.

FIGS. 6A and 6B show a flowchart of an exemplary operation of exchanging cartridges.

FIG. 7 shows an exemplary embodiment of a HotSwap bus installed in a small satellite.

FIG. 8 shows an exemplary HotSwap bus without cartridges installed.

FIG. 9 shows an exemplary HotSwap cartridge.

FIG. 10 shows an exemplary HotSwap cartridge with the cover plate removed and an example payload inside the interior of the cartridge.

FIG. 11 shows an exploded view of an exemplary HotSwap cartridge with a battery payload inside and with the cover plate removed.

FIG. 12 is a top down view of the bus, showing three empty slots for cartridges.

FIG. 13 is an exemplary view of the retractable pin mechanism.

FIG. 14 shows a first step in a method of exchanging an exemplary cartridge from an exemplary bus where an end effector, attached to a robot arm, is positioned near the HotSwap bus.

FIG. 15 shows a step in the method where the end effector attaches to the HotSwap bus by grabbing pegs.

FIG. 16 shows a step in the method where the end effector grabs a cartridge handle.

FIG. 17 shows a step in the method where the end effector turns keys to release clamps on the cartridge.

FIG. 18 shows a step in the method where the end effector pulls the cartridge out of the HotSwap bus.

FIG. 19 shows a step in the method where the end effector releases the HotSwap bus.

FIG. 20 shows a step in the method where the cartridge is removed from the HotSwap bus.

FIG. 21 shows a step in the method where a new cartridge is placed near the HotSwap bus.

FIG. 22 shows a step in the method where the end effector grabs the HotSwap bus.

FIG. 23 shows a step in the method where the new cartridge is inserted.

FIG. 24 shows a step in the method where keys are rotated to lock the new cartridge in place.

FIG. 25 shows a step in the method where the new cartridge and bus are released by the end effector and the swap is complete.

It should be clear that the description of the embodiments and attached figures set forth in this specification serves only for a better understanding, without limiting scope. It should also be clear that a person skilled in the art, after reading the present specification could adjust or amendments to the attached figures and above described embodiments that would still be covered by the present disclosure.

### DESCRIPTION

The present disclosure is not limited to particular systems, which may of course, vary. It is also to be understood that the terminology used herein is for the purpose of describing particular embodiments only, and is not intended to be limiting.

Unless defined otherwise, all technical and scientific terms used herein have the same meaning as commonly understood by one of ordinary skill in the art.

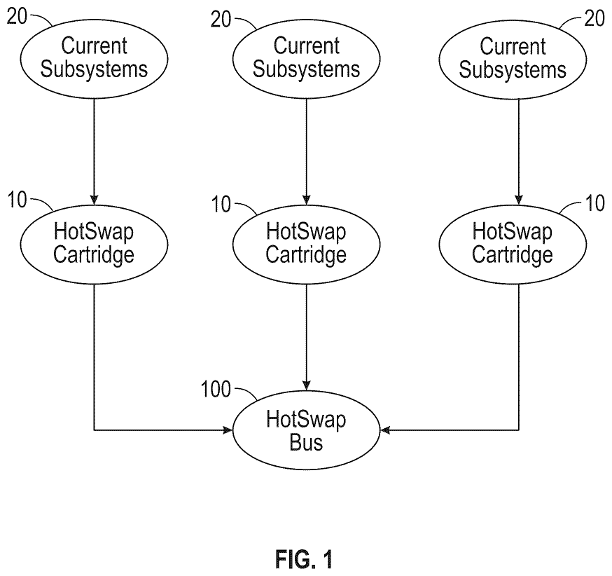

The HotSwap system includes a HotSwap bus and HotSwap cartridges containing payloads and subsystems and an optional HotSwap End Effector. An infographic of the HotSwap architecture is visible in FIG. 1. FIG. 1 shows a flow of removable cartridges 10 secured in the HotSwap bus 100 (also known as base, host, or console, but hereinafter referenced as HotSwap bus) of the HotSwap System. Useful subsystems 20 are attached to a cartridge which interfaces with the HotSwap bus 100. These cartridges 10, designed to accommodate current spacecraft standard subsystems/payloads, are intended to be removed, replaced, and/or exchanged in orbit, e.g., by a service vehicle to allow for rapid replacement of old, used, or damaged spacecraft systems. The HotSwap bus 100 secures these cartridges in place and allows for power and communication between subsystems 20.

The HotSwap cartriges 10 may be insterted into the bus through the use of an end effector E, which, in at least one exemplary form has the capabilities of a specifically designed mechanical “hand.” The end effector E can perform or assist in performing the task of aligning and extracting/inserting a cartridge(s).

The HotSwap system can be used, for example, in space to exchange components on satellites, or, in another exemplary aspect, can be used on Earth. When used prior to satellite launch, the HotSwap system provides a standardized and user friendly method to construct satellites by inserting cartridges. When used in space, the HotSwap system allows for future exchanges during a mission, since components are already utilizing the HotSwap system.

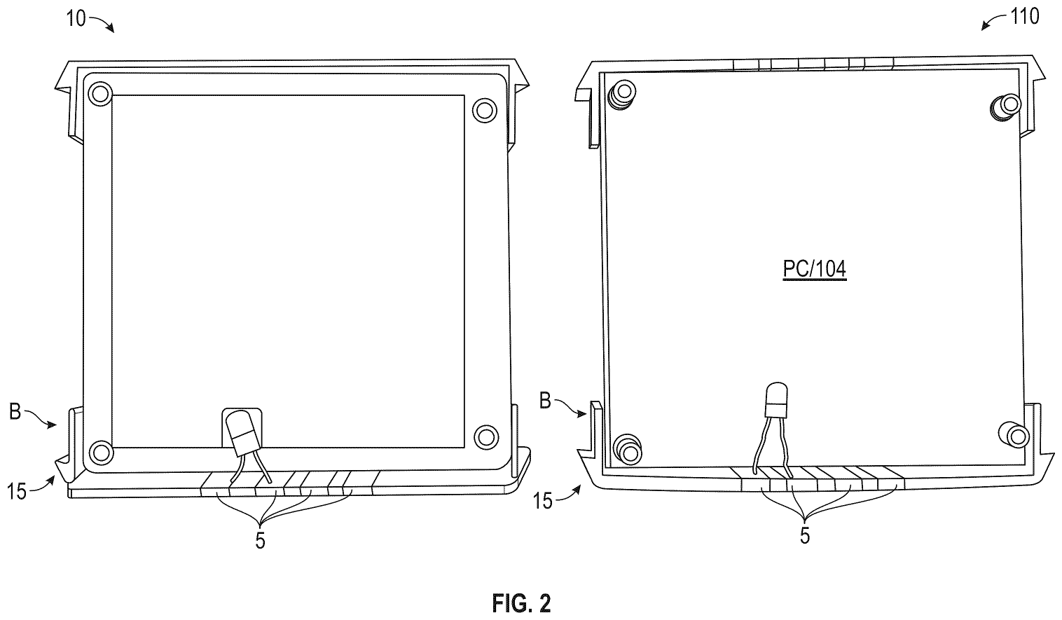

In at least one exemplary aspect, the HotSwap system is compatible with a PC104 interface commonly found on CubeSat type subsystems and payloads. An image of this prototype with a simulated battery supply and PC104 interface is shown in FIG. 2. FIG. 2 shows HotSwap cartridges with stand-in PC104 boards to demonstrate compatibility with current spacecraft standards. The cartridge on the left of FIG. 2 is a 3D model of an actual subsystem while the cartridge on the right of FIG. 2 is purely PC104 geometry standards.

The cartridge on the left of FIG. 2 is a 3D model of a power subsystem that follows the PC104 standard for CubeSat components. In at least this exemplary embodiment, the board is secured, e.g. by screws, into the cartridge via the standard mounting holes found on the PC104 standard. A more generic PC104 standard geometry is shown on the right side of FIG. 2 and uses the same mounting holes. Copper leads 5 represent connections to the PC104 board which will interface with capture/release mechanisms within the HotSwap bus 100. The small, angled piece 15 shown on the bottom B of the cartridges 10 is sized to hook into a mechanism or otherwise connect within the spacecraft bus.

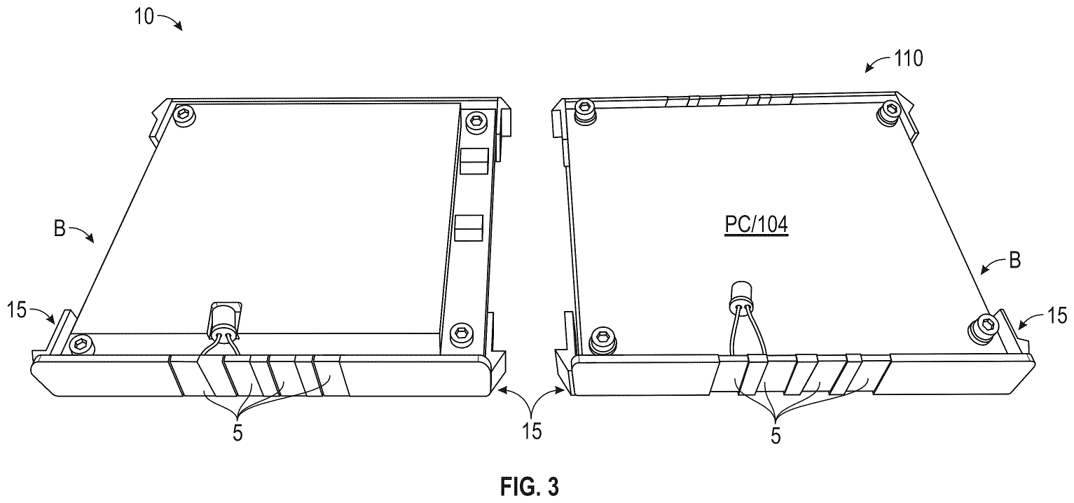

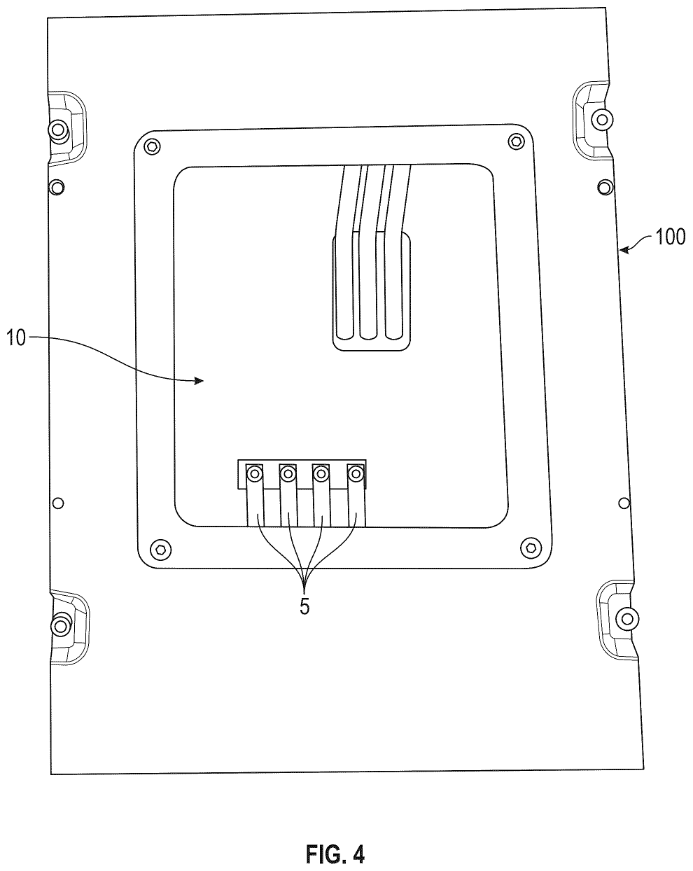

FIG. 3 shows a different angle of the HotSwap cartridge connected to the PC104 board. In FIG. 3, copper leads transfer power to an LED light indicating a successful power connection when inserted into the simulated HotSwap bus. Other pins are available for serial communications. As shown in FIG. 3, the copper leads are clearly visible and would interface with mechanisms inside the HotSwap spacecraft bus. LED lights are connected to the copper strips which are shown to visualize a successful connection with the mechanisms inside of the Simulated HotSwap bus, which is shown in FIG. 4.

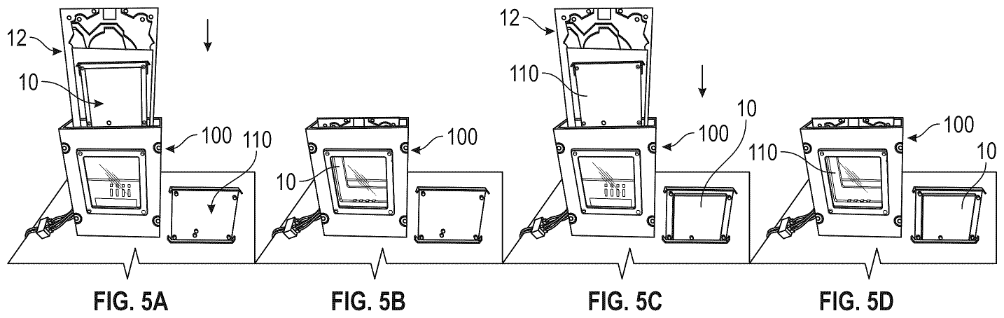

The cartridges are designed to swap in/out of the bus to provide the on board subsystem's service to the satellite. As shown in FIGS. 5A, 5B, 5C, and 5D, a first cartridge is placed inside the bus to produce a green light. The first cartridge is then swapped out and replaced with a second cartridge which provides blue light.

In at least one exemplary embodiment, the HotSwap unit or system is comprised of the following aspects:

### A HotSwap Cartridge

Cartridge includes a handling interface (such as a handle or plate to hold or grasp)
Cartridge includes an electrical interface to communicate with bus
Cartridge is capable of hosting a subsystem (such as camera, antenna, sensor, weapon, etc.)

### A HotSwap Bus

Bus is permanently attached to the host satellite (typically)
Bus is able to receive commands or mechanical operation for ejecting/accepting a cartridge
Bus has electrical capabilities to communicate with the cartridge when inserted
Bus has mechanical means to eject/receive/secure a cartridge

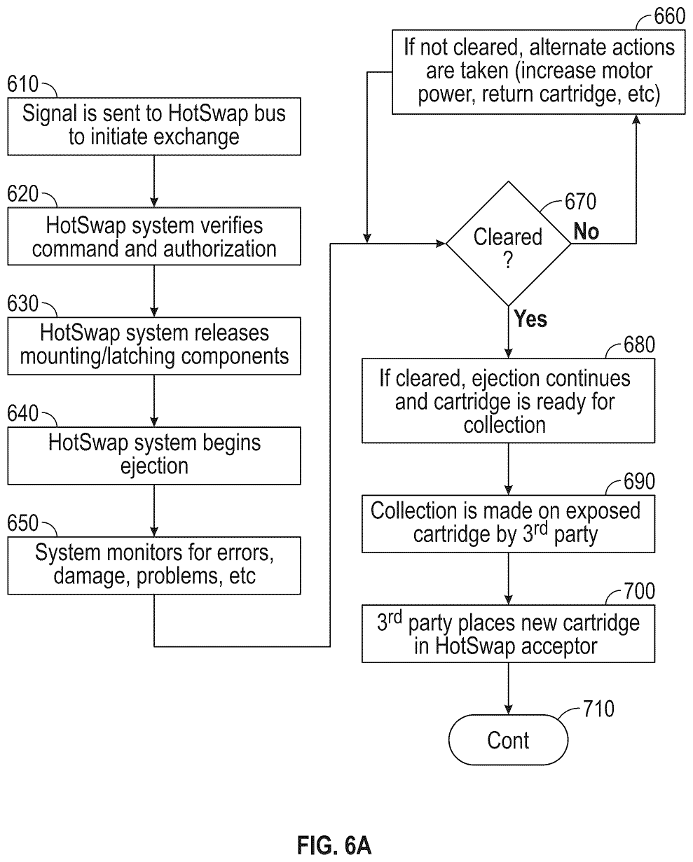

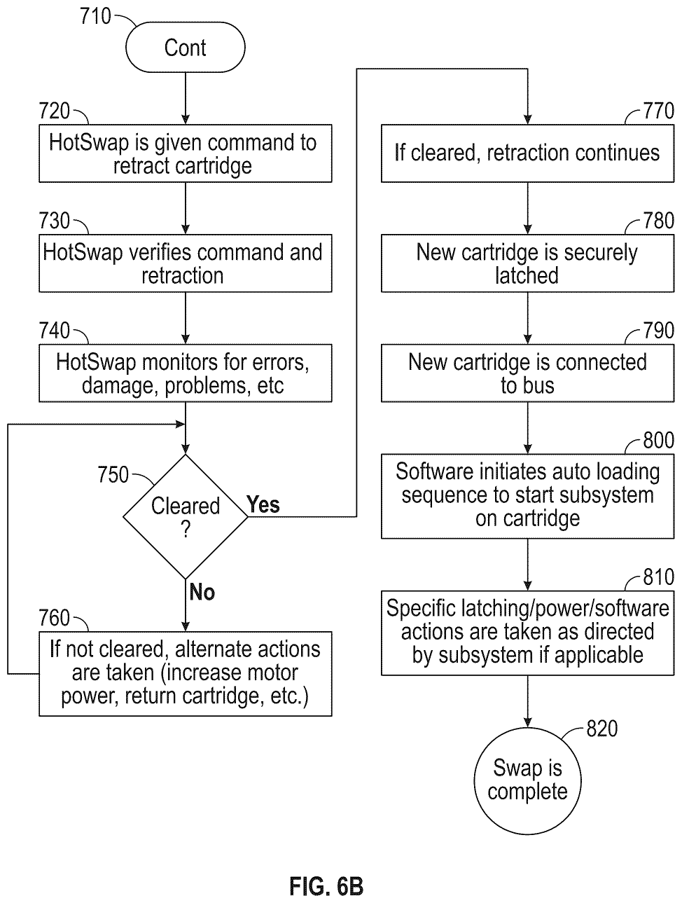

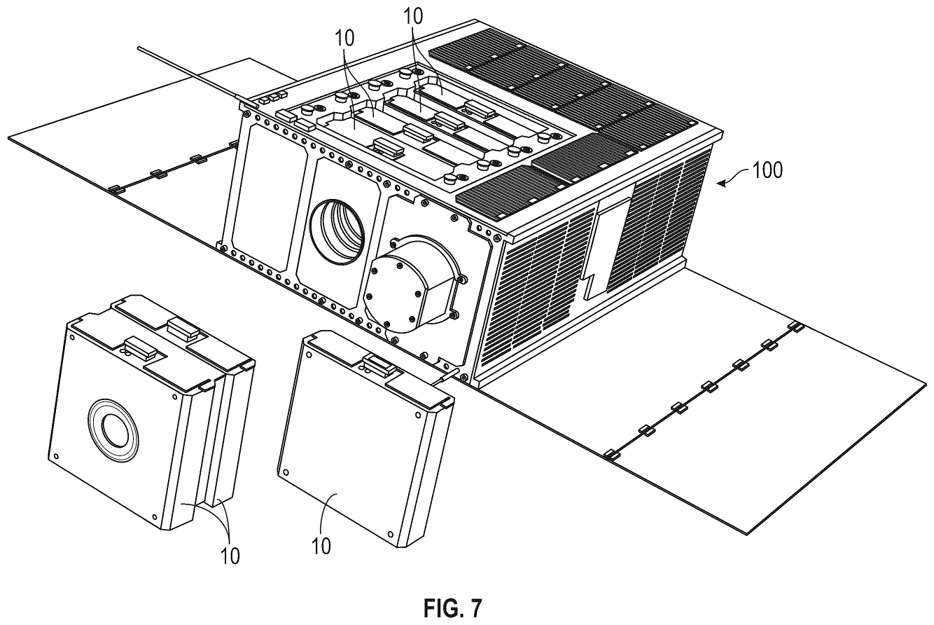

One exemplary flowchart of an exemplary operation of exchanging cartridges is shown in FIGS. 6A and 6B. In this example, the steps for exchange include:
1) Signal is sent to HotSwap bus to initiate exchange (Step 610)
2) HotSwap system verifies command and authorization (Step 620)
3) HotSwap system releases mounting/latching components (Step 630)
4) HotSwap system begins ejection (Step 640)
5) System monitors for errors, damage, problems, etc. (Step 650)
6) If cleared (check performed at Step 670), ejection continues and cartridge is ready for collection (as shown at Step 680)
   a. If not cleared(the method proceeds to Step 660), alternate actions are taken (increase motor power, return cartridge, etc.)
7) Collection is made on exposed cartridge by 3^{rd} party (Step 690)
8) 3^{rd} party places new cartridge in HotSwap acceptor (Step 700) (the transition is shown at Step 710 in moving from FIG. 6A to FIG. 6B)
9) HotSwap is given command to retract cartridge (Step 770)
10) HotSwap verifies command and retraction (Step 730)
11) HotSwap monitors for errors, damage, problems, etc. (Step 740)
12) If cleared (as checked at Step 750), retraction continues (as shown at Step 770)
   a. If not cleared (the method proceeds to Step 760), alternate actions are taken (increase motor power, return cartridge, etc.)
13) New cartridge is securely latched (Step 780)
14) New cartridge is connected to bus (Step 790)
15) Software initiates auto loading sequence to start subsystem on cartridge (Step 800)
16) Specific latching/power/software actions are taken as directed by subsystem if applicable (Step 810)
17) Swap is complete (Step 820)

The exemplary process shown in FIGS. 6A and 6B, in at least one instance, involves a third party, which can be a robot, an astronaut, or other, including a ROAMER spacecraft or an element or component thereof.

FIG. 7 shows one embodiment of a HotSwap bus 100 installed in an exemplary small satellite 150. Several HotSwap cartridges 10 are shown inside the bus 100 in an installed position. Outside of the satellite 150 additional other HotSwap cartridges 110 are shown.

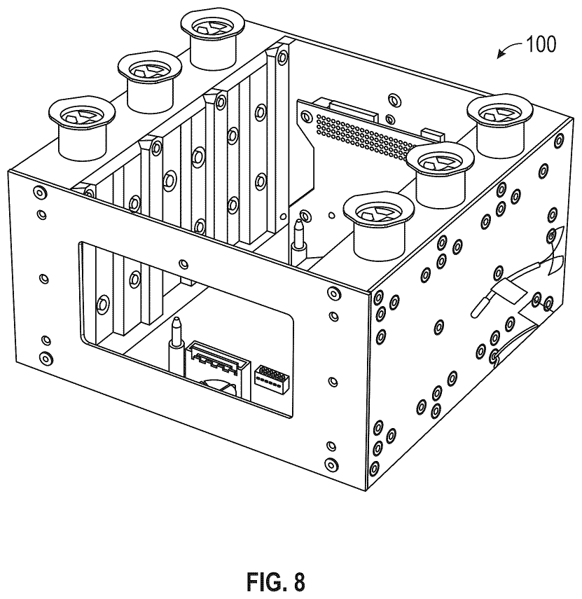

FIG. 8 shows a HotSwap bus 100 without cartridges installed. The bus 100 is shown with slots for receiving cartridges in specific alignment, but could include more or fewer slots depending on the preferred design.

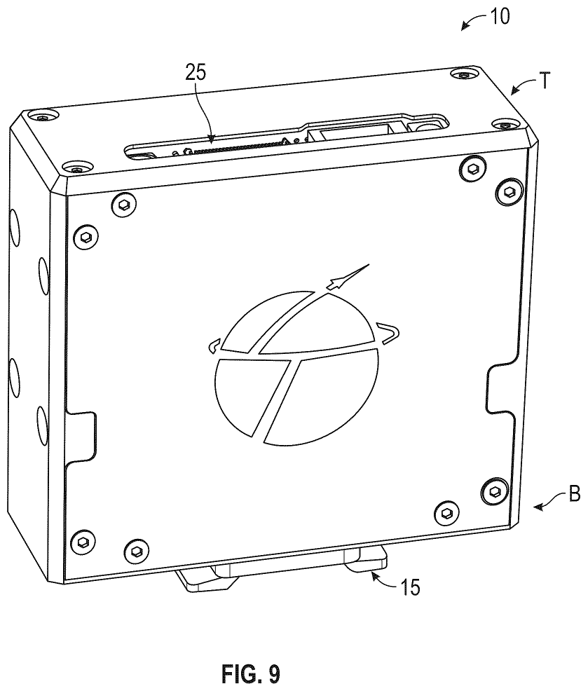

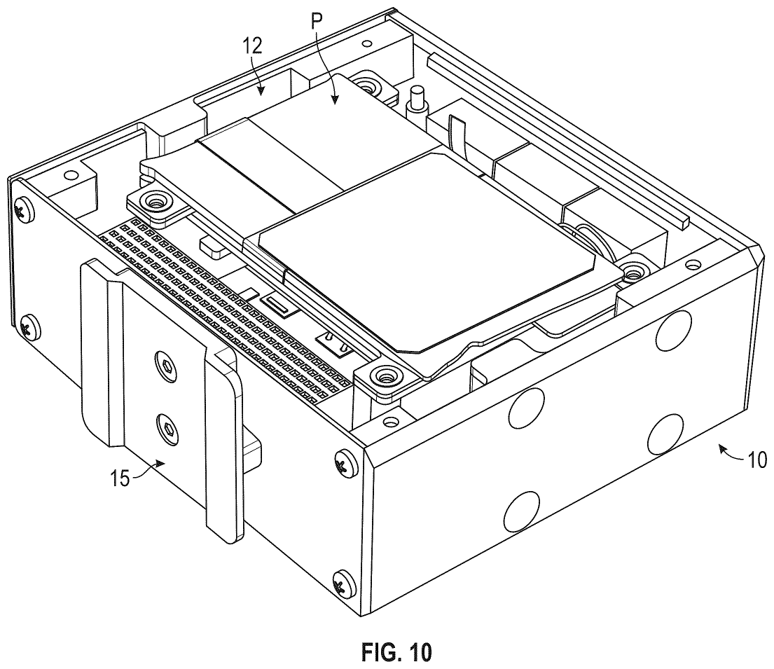

FIG. 9 shows a HotSwap cartridge 10 that comprises a rectangular design and can include multiple panels that can be removed/replaced/exchanged as desired. A cover plate CP is shown attached to the cartridge 10 with screws, though other attachment means for the cover plate CP could be utilized to allow the cover plate CP to be removed or replaced. A handle 15 is shown at a bottom B of the cartridge 10. The handle 15 as shown is formed of metal, but could be formed of alternative materials or composites of materials. The handle 15 could be arranged in a different position and could include multiple sections, connected or disconnected. The handle 15 is used in at least one exemplary embodiment by an end effector to hold or grasp the cartridge 10. The cartridge is shown with exposed pin holes 25 at the top T to allow the pin holes 25 to connect the cartridge 10 to the bus 100 once inserted.

FIG. 10 shows the exemplary HotSwap cartridge 10 with the cover plate CP (FIG. 9) removed and an example payload P inside the interior 12 of the cartridge 10. A side view of handle 15 is also shown in FIG. 10.

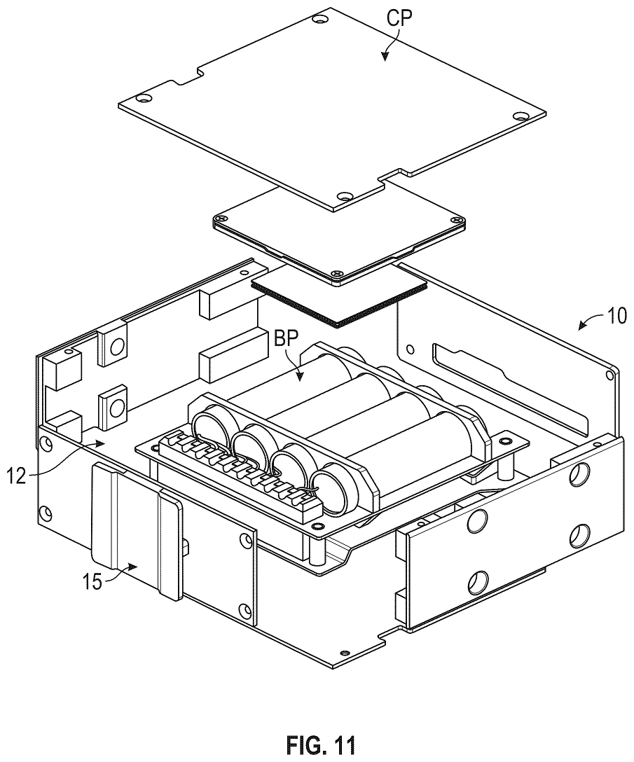

FIG. 11 shows an exploded view of a HotSwap cartridge 10 with a battery payload BP installed in the interior 12 with cover plate CP removed. A side view of handle 15 is also shown in FIG. 10.

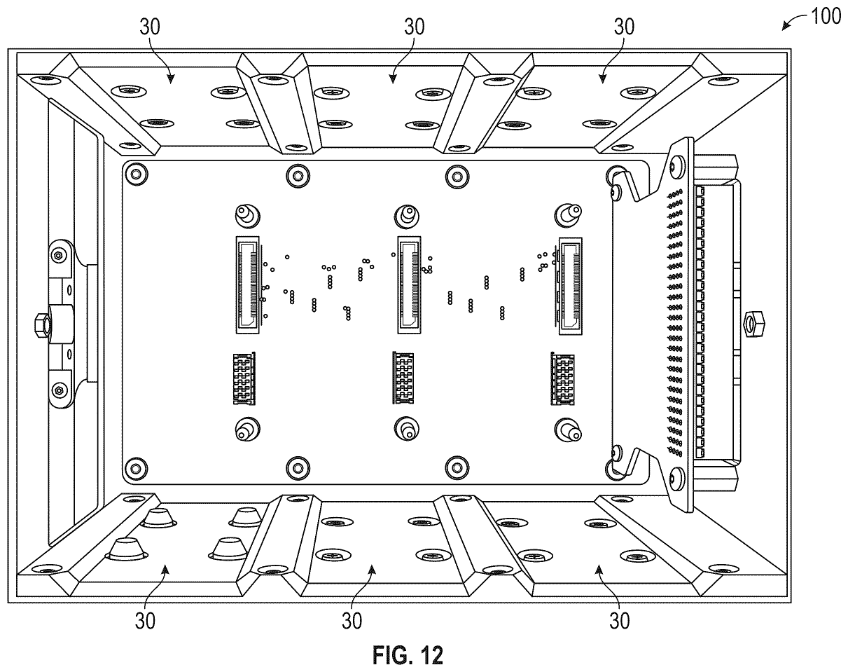

FIG. 12 is a top down view of the bus, showing three empty slots 30 for receiving cartridges 10. Connectors 50 are shown at the bottom B of the bus 100 connect to a cartridge 10 once inserted to transmit electrical signals and/or power. Retractable pins along the sides of the slots 30 insert once the cartridge 10 is installed in the interior of the bus 100 to hold the cartridge 10 in place.

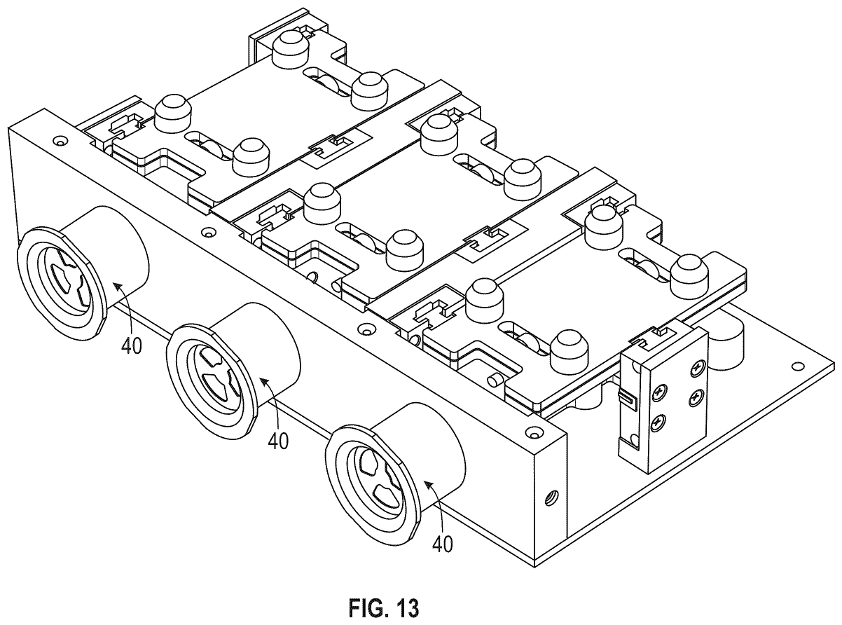

FIG. 13 is an example of the retractable pin mechanism. The cylinders house rotatable rods 40 which are activated by a key. When rotated, the retracting pins are pushed outward and enter holes in the cartridge 10 to keep the cartridge 10 secure.

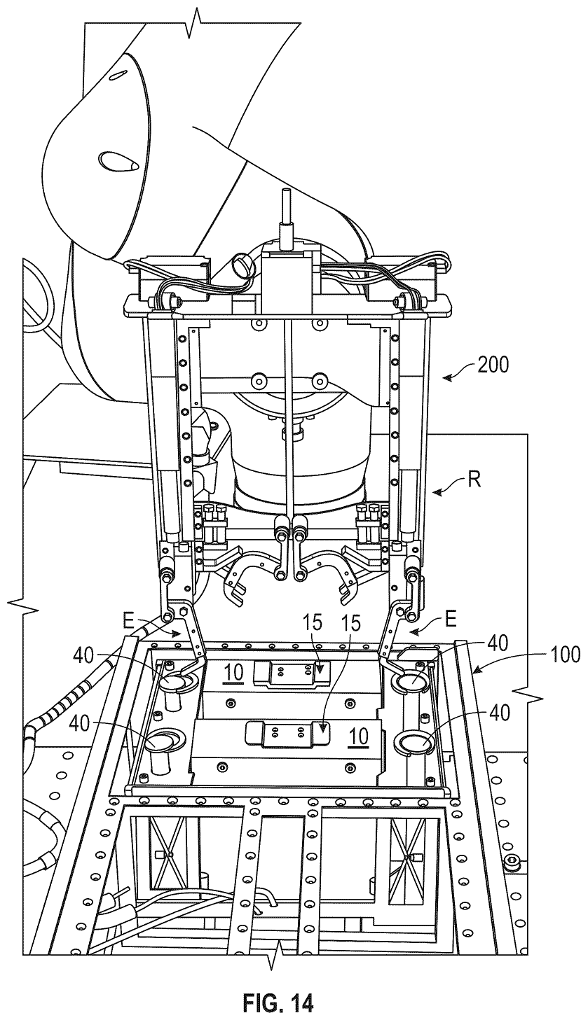

FIG. 14 shows a first step in a method of removing and exchanging an exemplary cartridge 10 from an exemplary bus 100. As shown in FIG. 14, an end effector E, attached to a robot arm R, is positioned near the HotSwap bus 100.

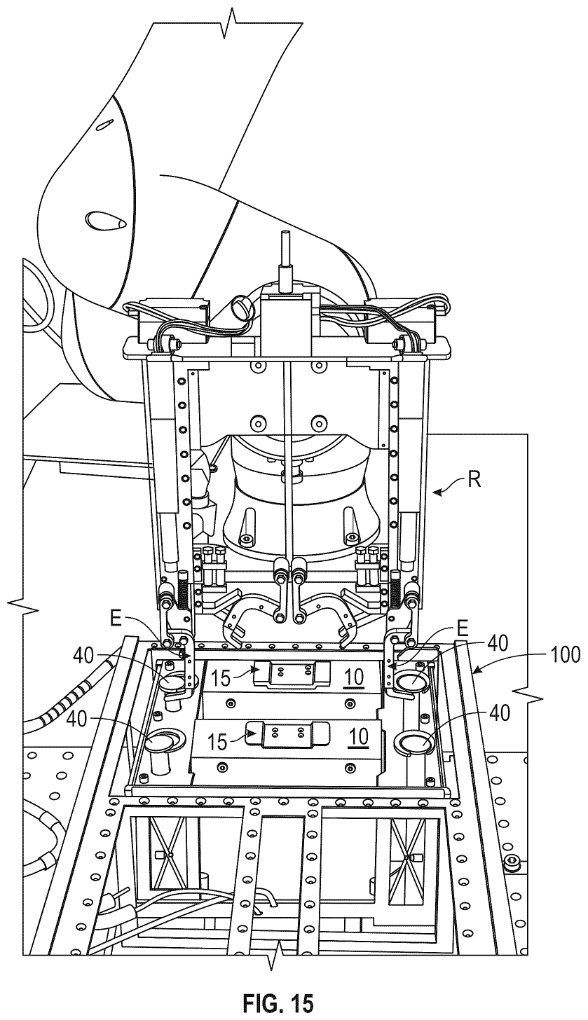

FIG. 15 shows a step in the method where the end effector E attaches to the HotSwap bus 100 by grabbing pegs 40. Four pegs 40 are shown on bus 100, but more or less could be included depending on robot arm R configuration, the size of the bus 100, or other design factors.

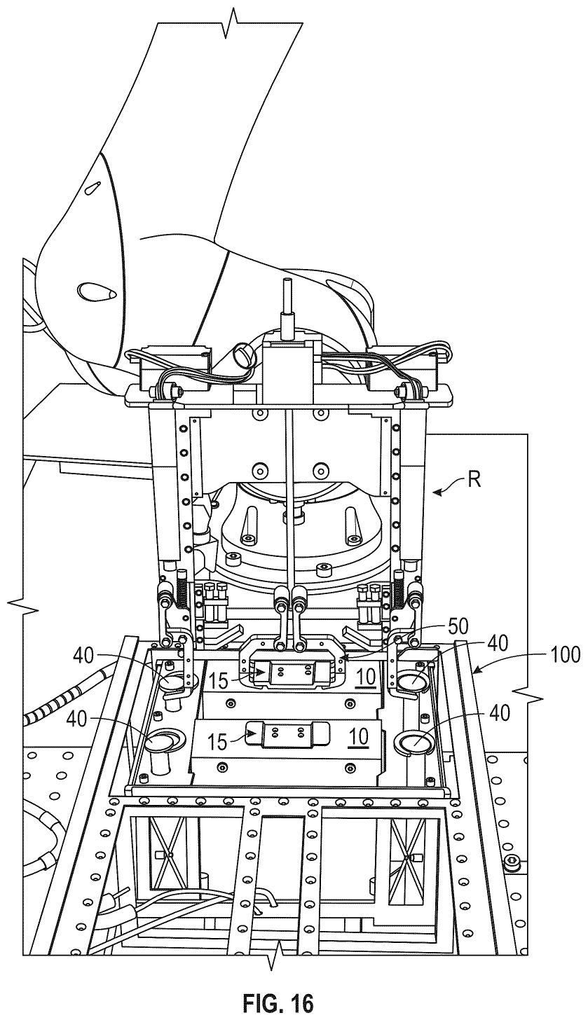

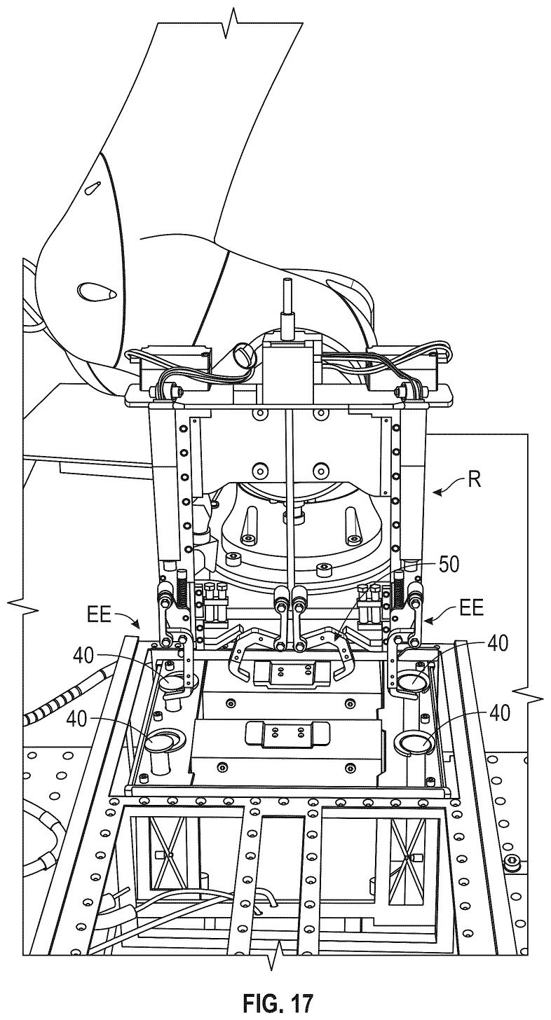

FIG. 16 shows a step in the method where the end effector E grabs cartridge handle 15. FIG. 17 shows a step in the method where the end effector E turns keys to release clamps on the cartridge 10.

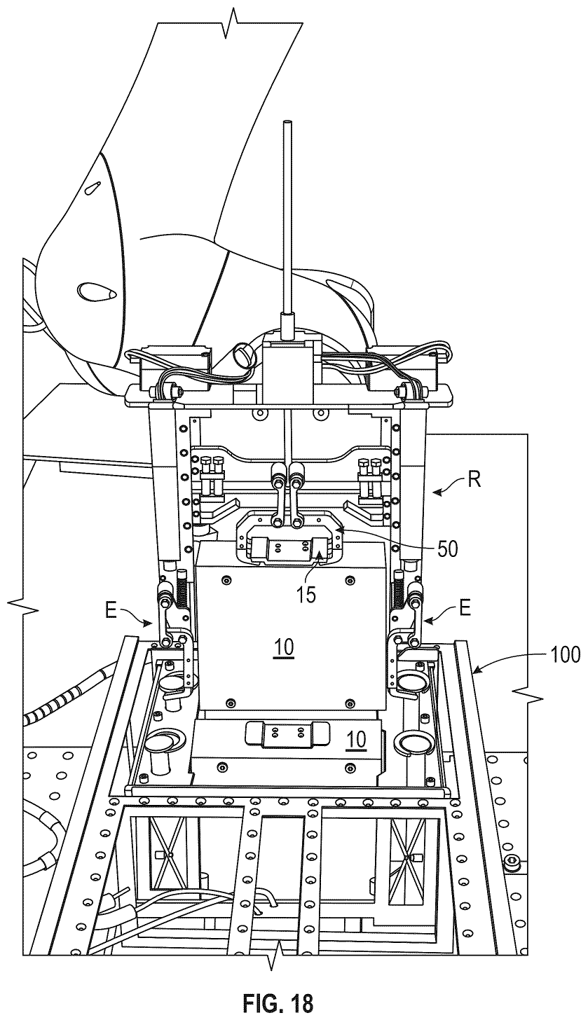

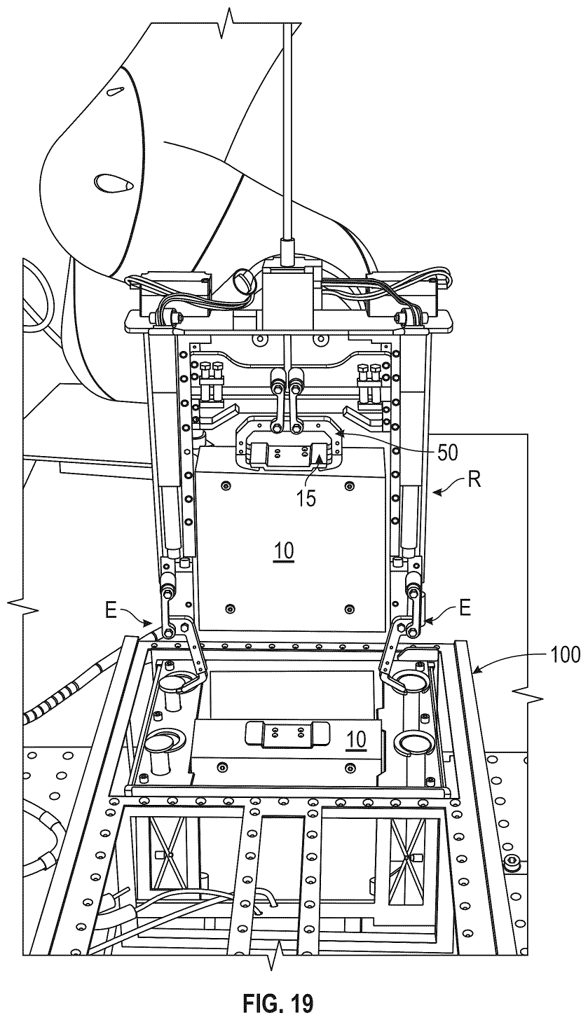

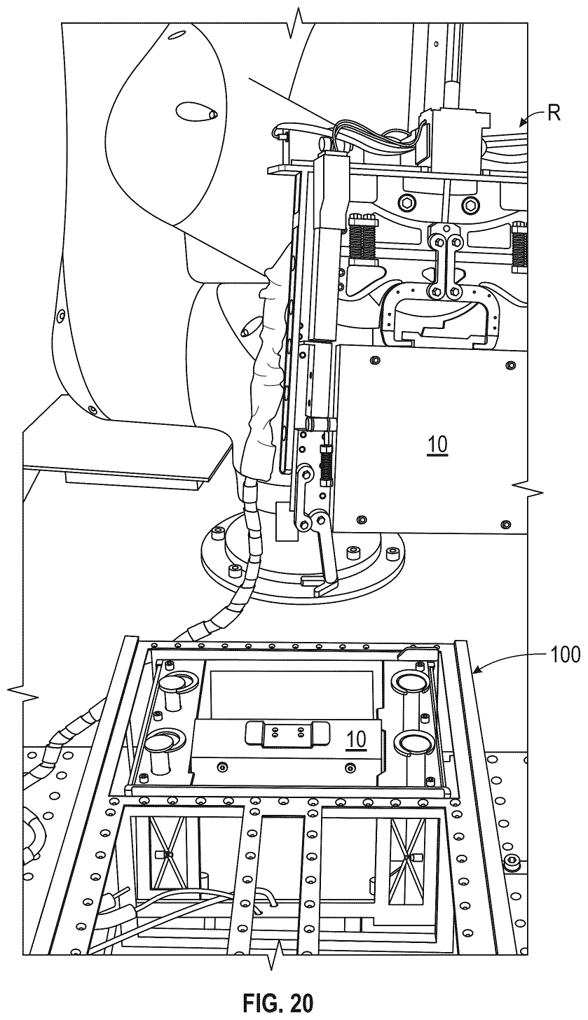

FIG. 18 shows a step in the method where the cartridge 10 is pulled by handle 15 out of the HotSwap bus 100. FIG. 19 shows a step in the method where the end effector E releases the HotSwap bus 10. FIG. 20 shows a step in the method where the cartridge 10 is removed from the HotSwap bus 10. Although not shown, the cartridge 10 is moved away from the

HotSwap bus 100 and released by robot arm R. The robot arm R then grasps a new cartridge 110.

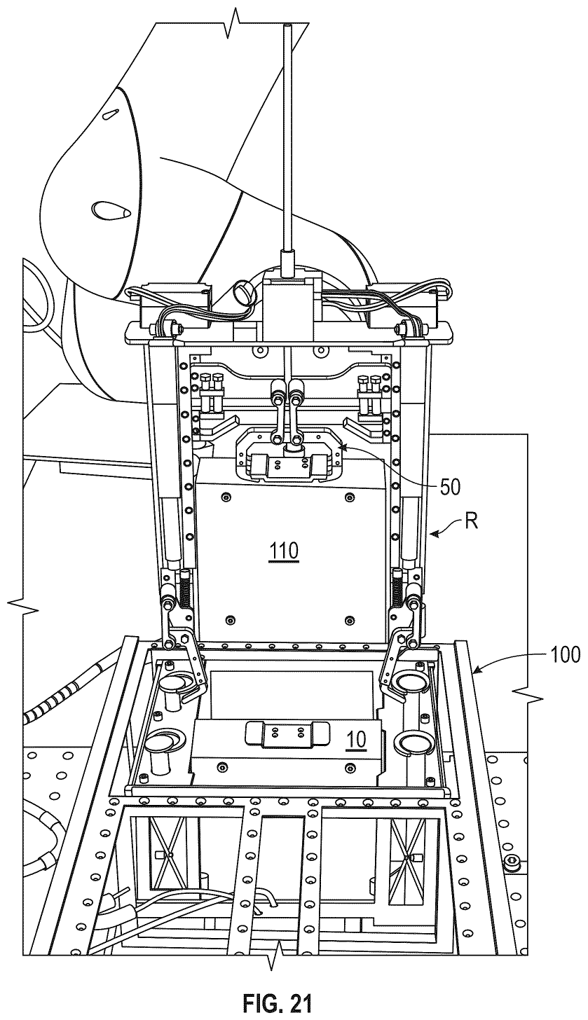

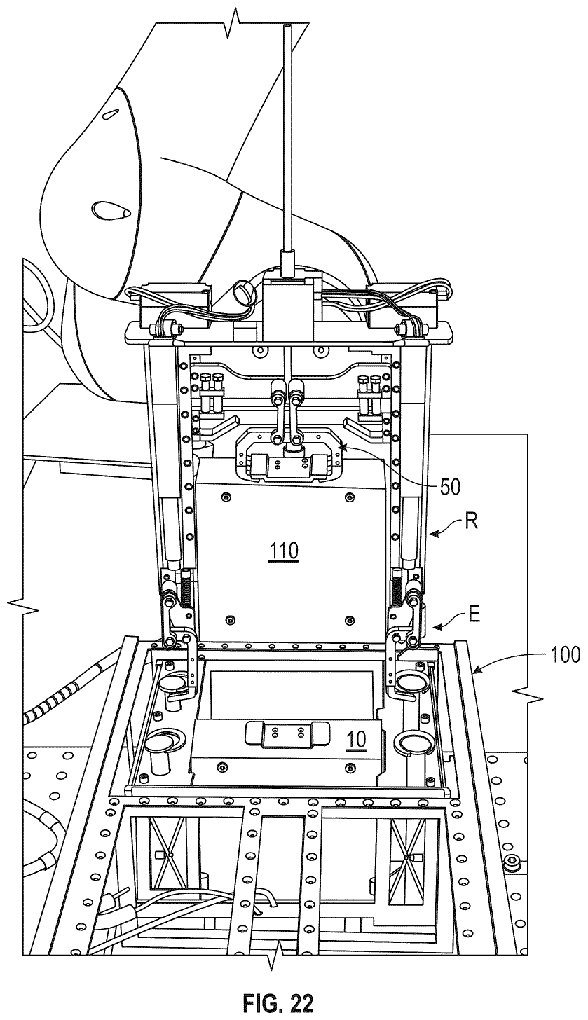

FIG. 21 shows a step in the method where new cartridge 110 is placed near the HotSwap bus 100. FIG. 22 shows a step in the method where the end effector E grabs the HotSwap bus 100.

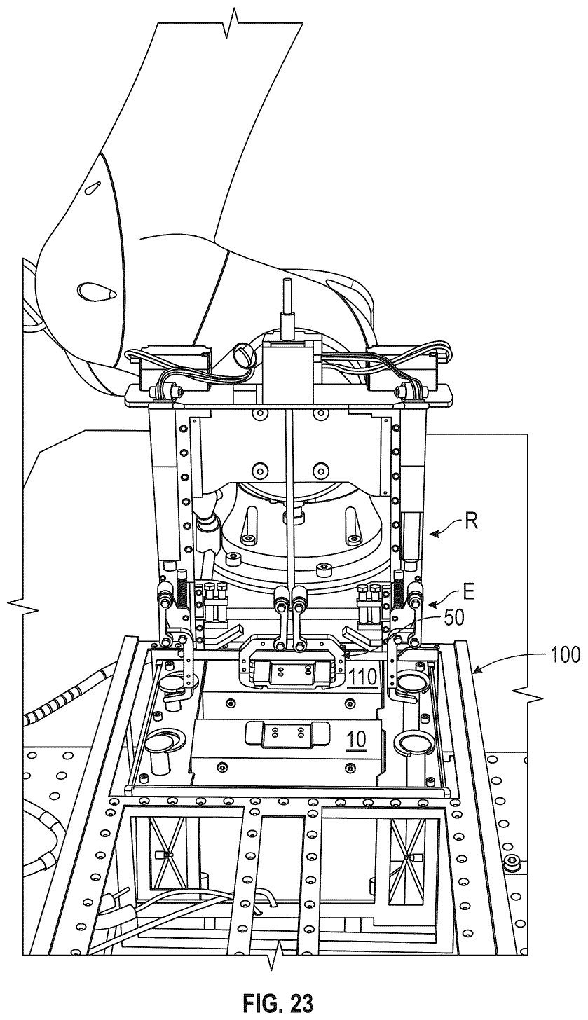

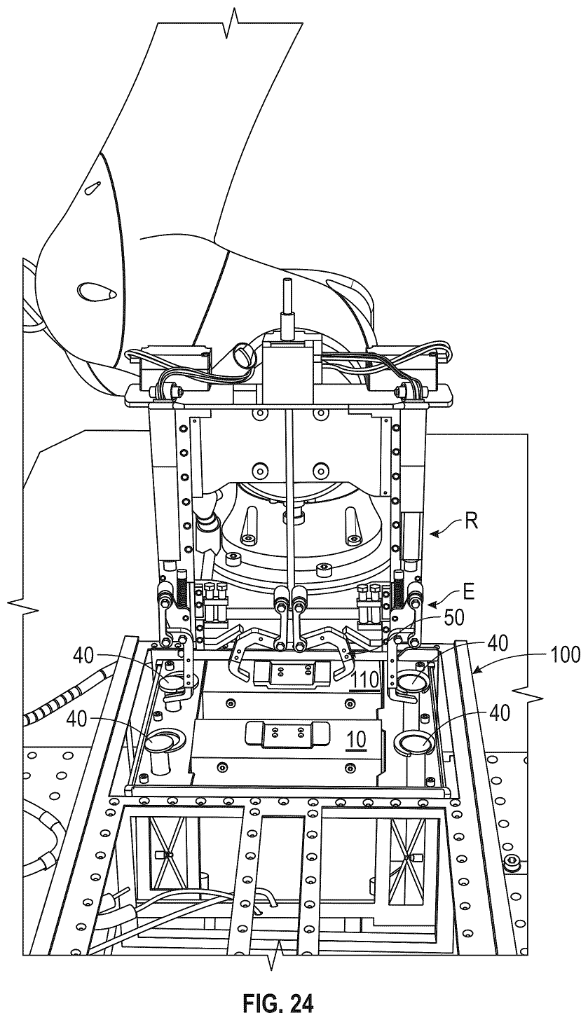

FIG. 23 shows a step in the method where the new cartridge 110 is inserted in a slot 30 of the HotSwap bus 100. FIG. 24 shows a step in the method where keys are rotated to lock the new cartridge 110 in place in HotSwap bus 100.

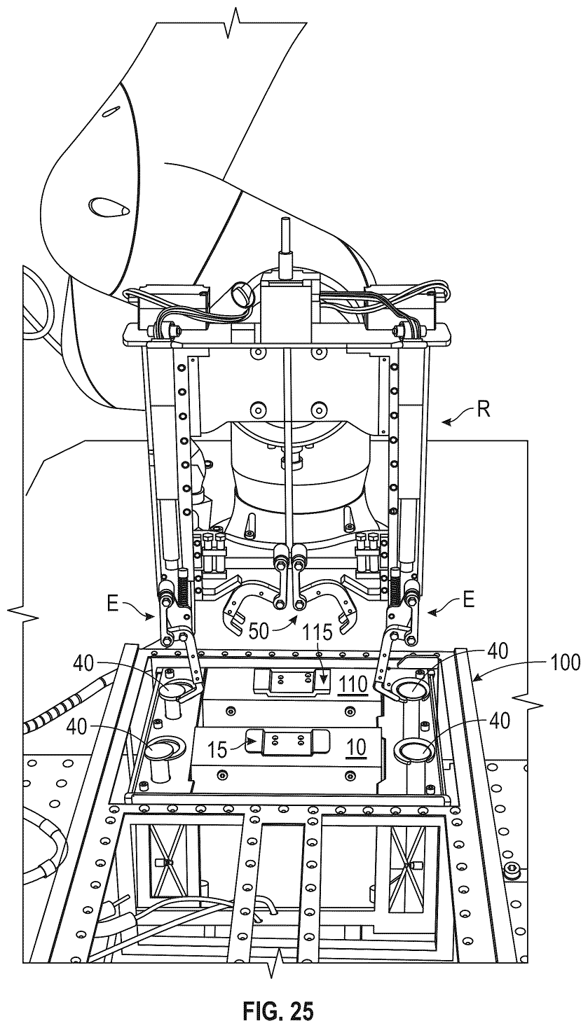

FIG. 25 shows a step in the method where the new cartridge 110 and bus 100 are released by the end effector E and the swap is complete. The robot arm R is then moved away from the HotSwap bus 100 with new cartridge 110 installed therein.

In one aspect, the present disclosure provides a method of exchanging a cartridge in a satellite system that includes attaching a robot arm to the cartridge disposed in an interior of a bus, releasing mounting components to separate the cartridge from a secured position in the bus, removing the cartridge from the interior of the bus, releasing the cartridge from the robot arm, attaching the robot arm to a new cartridge, and, installing the new cartridge in the bus. The robot arm can attach to at least one pin on the cartridge prior to releasing the mounting components. The at least one pin can be rotated to release the mounting components. The method can further comprise monitoring for errors, damages, or problems during the removing of the cartridge from the interior of the bus. The method can further comprise checking whether the cartridge is entirely out of the interior of the bus during the removing of the cartridge, and, if the cartridge is not entirely out of the interior of the bus, the method can institute alternative actions. The alternative actions can include at least increasing motor power or returning the cartridge into the interior of the bus. The new cartridge can be securely latched in the bus after installation. After the new cartridge is securely latched, an auto loading sequence can be initiated to start a subsystem on the new cartridge. Further, additional latching, power, or software actions can be taken as directed by the subsystem if applicable.

In another aspect, the present disclosure provides a satellite system that includes a bus, at least one cartridge installed in the bus, the at least one cartridge includes connection components to interface with the bus and at least one additional satellite subsystem, and the at least one cartridge includes a cartridge subsystem capable of being operated by software or hardware in communication with the bus. The at least one cartridge can be sized to be installed within at least one slot in the bus. The at least one cartridge can include a handle capable of interfacing with a robot to remove or install the at least one cartridge from or into the at least one slot in the bus. The at least one cartridge subsystem can be, for example, a battery pack, camera, antenna, sensor, or weapon.

In another aspect, the present disclosure provides a system that includes a bus, at least one cartridge installed in the bus, a subsystem installed in the at least one cartridge, and the at least one cartridge can be removed from the bus and a new cartridge can be inserted into the bus. The at least one cartridge and the bus can send electrical signals or electrical power to each other through a contact junction. In one aspect, a payload, subsystem, or payload and subsystem can be installed inside the at least one cartridge and a connection between the at least one cartridge and the bus can send and receive electrical signals or power. The bus can be installed on a satellite and the satellite receives power from or sends electrical signals to the bus. In one aspect, a connection or junction between the at least one cartridge and the bus can allow the satellite to send electrical signals or receive power through the connection. In one aspect, an end effector can be used to mechanically insert the at least one cartridge into the bus or remove the at least one cartridge out of the bus. The at least one cartridge can be held in place by a physical mounting system comprising penetrating rods or clamps.

The present disclosure can be understood more readily by reference to the instant detailed description, examples, and claims. It is to be understood that this disclosure is not limited to the specific systems, devices, and/or methods disclosed unless otherwise specified, as such can, of course, vary. It is also to be understood that the terminology used herein is for the purpose of describing particular aspects only and is not intended to be limiting.

The instant description is provided as an enabling teaching of the disclosure in its best, currently known aspect. Those skilled in the relevant art will recognize that many changes can be made to the aspects described, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the instant description is provided as illustrative of the principles of the present disclosure and not in limitation thereof.

As used herein, the singular forms “a”, “an”, and “the” include plural referents unless the context clearly dictates otherwise. Thus, for example, reference to a “body” includes aspects having two or more bodies unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Although several aspects of the disclosure have been disclosed in the foregoing specification, it is understood by those skilled in the art that many modifications and other aspects of the disclosure will come to mind to which the disclosure pertains, having the benefit of the teaching presented in the foregoing description and associated drawings. It is thus understood that the disclosure is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described disclosure.

What is claimed is:

1. A method of exchanging a cartridge in a satellite system, the method comprising:
attaching a robot arm to the cartridge disposed in an interior of a bus;
releasing mounting components to separate the cartridge from a secured position in the bus;
removing the cartridge from the interior of the bus;
releasing the cartridge from the robot arm;
attaching the robot arm to a new cartridge; and,
installing the new cartridge in the bus.

2. The method of claim 1 wherein the robot arm attaches to at least one pin on the cartridge prior to releasing the mounting components.

3. The method of claim 2 where in the at least one pin is rotated to release the mounting components.

4. The method of claim 1 further comprising:
monitoring for errors, damages, or problems during the removing of the cartridge from the interior of the bus.

5. The method of claim 1 further comprising:
checking whether the cartridge is entirely out of the interior of the bus during the removing of the cartridge; and,
wherein, if the cartridge is not entirely out of the interior of the bus, the method institutes alternative actions.

6. The method of claim 5 wherein the alternative actions include at least increasing motor power or returning the cartridge into the interior of the bus.

7. The method of claim 1 wherein the new cartridge is securely latched in the bus after installation.

8. The method of claim 7 wherein, after the new cartridge is securely latched, an auto loading sequence is initiated to start a subsystem on the new cartridge.

9. The method of claim 8 wherein additional latching, power, or software actions are taken as directed by the subsystem if applicable.

10. A satellite system comprising:
a bus;
at least one cartridge installed in the bus;
wherein the at least one cartridge includes connection components to interface with the bus and at least one additional satellite subsystem;
wherein the at least one cartridge includes a cartridge subsystem capable of being operated by software or hardware in communication with the bus.

11. The satellite system of claim 10 wherein the at least one cartridge is sized to be installed within at least one slot in the bus.

12. The satellite system of claim 11 wherein the at least one cartridge includes a handle capable of interfacing with a robot to remove or install the at least one cartridge from or into the at least one slot in the bus.

13. The satellite system of claim 10 wherein the at least one cartridge subsystem is a battery pack, camera, antenna, sensor, or weapon.

14. A system comprising:
a bus;
at least one cartridge installed in the bus;
a subsystem installed in the at least one cartridge;
wherein the at least one cartridge can be removed from the bus and a new cartridge can be inserted into the bus.

15. The system of claim 14 wherein the at least one cartridge and the bus can send electrical signals or electrical power to each other through a contact junction.

16. The system of claim 14 wherein a payload, subsystem, or payload and subsystem is installed inside the at least one cartridge and a connection between the at least one cartridge and the bus can send and receive electrical signals or power.

17. The system of claim 14 wherein the bus is installed on a satellite and the satellite receives power from or sends electrical signals to the bus.

18. The system of claim 14 wherein a connection or junction between the at least one cartridge and the bus allows the satellite to send electrical signals or receive power through the connection.

19. The system of claim 14 wherein an end effector is used to mechanically insert the at least one cartridge into the bus or remove the at least one cartridge out of the bus.

20. The system of claim 14 wherein the at least one cartridge is held in place by a physical mounting system comprising penetrating rods or clamps.
